(19) United States
(12) Patent Application Publication
(10) Pub. No.: US 2026/0352347 A1
(43) Pub. Date: Nov. 5, 2026

(54) Modular Peer-to-Peer Communication Ecosystem with Binary, Acoustic, Symbolic and Identity-Based Layers

(71) Applicant: EMMANUEL MOISÉS MELLADO MARTINEZ, MADRID (ES)

(72) Inventor: EMMANUEL MOISÉS MELLADO MARTINEZ, MADRID (ES)

(21) Appl. No.: 19/211,883

(22) Filed: May 19, 2025

(30) Foreign Application Priority Data
May 4, 2025 (ES) P202530369

(51) Int. Cl. H04B 13/00; H04L 67/104

(52) U.S. Cl. CPC H04B 13/00; H04L 67/104

(57) ABSTRACT

The invention describes a modular peer-to-peer (P2P) communication ecosystem composed of five evolutive layers: Teethlion, CoreRotator (with VPortOS), GODLayer, ASIBIM, and MozartNode. Teethlion is a symbolic P2P framework that supports encrypted communication and dynamic roles among nodes. CoreRotator enables portless communication via ephemeral hash identifiers (vhash) that replace conventional port/IP addressing. GODLayer introduces symbolic packet fragmentation (QPKTs), allowing resilient data flow even in hostile environments. ASIBIM adds symbolic overlays over binary channels using jitter, timing, and structure. MozartNode transmits symbolic acoustic data across air and water using musical parameters. Together, they create a secure, adaptive architecture for online and offline symbolic communication without requiring centralized infrastructure.

### BACKGROUND

### Detailed Description

Current communication systems rely predominantly on IP-based architectures (IPv4/IPv6), port-based session handling (TCP/UDP), and centralized intermediaries for message routing, authentication, and encryption. These legacy models are illustrated in FIG. 1, which contrasts the centralized frameworks with the modular Teethlion architecture (1).

While decentralized overlays such as Tor, I2P, and mesh networking protocols (e.g., BATMAN, ZigBee, BLE) attempt to address anonymity or low-power communication, they continue to depend on traditional port models, static routing, or centralized infrastructure. In contrast, FIG. 1 shows the Teethlion modular framework (1), incorporating the CoreRotator (2), GODLayer (3), ASIBIM (4), and MozartNode (5).

Acoustic communication has been limited to niche applications (e.g., sonar or telemetry), lacking symbolic structure or resilience. The MozartNode subsystem, shown in FIG. 5, extends acoustic communication across wired (26), air (27), and underwater (28) channels, embedding symbolic metadata (24) and decoding structures (25).

Symbolic communication has not been standardized outside of internal AI grammars or experimental sensor networks. FIG. 4 illustrates how raw binary signals (17) and electromagnetic timing errors (18) are processed by a temporal pattern encoder (19) to produce symbolic QPKTs (20), later interpreted by resilient receivers (22).

Protocols today assume payload presence as the sole conveyor of meaning, ignoring symbolic structures encoded in timing, repetition, or entropy. FIG. 3 demonstrates this limitation and shows how GODLayer introduces fragmentation (12), hyper-fragmentation (13), and packet reassembly (15) across hostile contexts such as firewalls, before reaching receivers (16).

Teethlion addresses these gaps via a modular symbolic architecture that includes: (i) a peer-to-peer framework (1) with role evolution, (ii) CoreRotator (2) for ephemeral identifiers, (iii) GODLayer (3) for symbolic QPKTs, (iv) ASIBIM (4) for binary overlays, and (v) MozartNode (5) for acoustic signaling. This is shown holistically in FIG. 1.

Together, these components enable symbolic communication across wired, wireless, and underwater media—with or without Internet access. For example, FIG. 8 illustrates the vhash handshake protocol, where a client (37) and server (38) exchange ephemeral identifiers (9) through CoreRotation modules (2) before establishing secure sessions.

Unlike traditional systems, Teethlion can operate fully offline in LANs, disaster areas, or sovereign deployments. FIG. 14 illustrates a multilayer deployment with LAN (62), MAN (63), WAN (64), and GAN (65) rings, including different node roles: user nodes (54), bootstrap (55), relay (56), AI nodes (66), and hybrid nodes (67).

This makes the system resilient, adaptable, and suitable for critical infrastructure, decentralized environments, or censorship-resistant networks. The encrypted peer-to-peer overlay shown in FIG. 11 highlights how nodes (47, 48, 49) exchange data streams (51) through secure connections (50).

The present invention is a symbolic, modular, and evolutive communication ecosystem comprising five core subsystems: Teethlion (1), CoreRotator (2), GODLayer (3), ASIBIM (4), and MozartNode (5). FIG. 6 shows how virtual hashes are generated by VPortOS (29), VPortAI (30), and VPortQ (31), with combined outputs (32).

This is the foundational peer-to-peer network framework supporting encrypted communication between symbolic nodes. Nodes are modular, hybrid, and evolutive by design. As shown in FIG. 12, dynamic roles such as user (54), bootstrap (55), and relay (56) are reassigned during execution (53), enabling adaptability to mission context.

Teethlion currently operates over standard transport protocols (TCP, UDP, WebSocket), but is designed to evolve into a portless, identity-based model via CoreRotator and VPortOS. FIG. 7 shows how CoreRotation (2) mediates applications (33) and virtual/physical ports (35, 36), replacing legacy port assignments.

CoreRotator eliminates traditional ports by issuing ephemeral, time-limited virtual identifiers (vhash). In FIG. 2, Application 1 (6) and Application 2 (7) connect via SDK Layer (8) to CoreRotator (2), which generates vhash values (9) for Portless Communication endpoints (10), validated by Client Applications (11).

GODLayer handles packet fragmentation and symbolic transport using QPKTs. As shown in FIG. 3, fragmentation (12), hyper-fragmentation (13), and GODLayer (3) cooperate with defragmentation (15) to reconstruct symbolic flows, even when payloads are empty or symbolic.

ASIBIM adds symbolic overlays over binary transport. In FIG. 4, raw binary signals (17) pass through encoders (19) to produce symbolic data (20), interpreted at receivers (21, 22). This enables metadata, timing patterns, and symbolic grammars to coexist with legacy protocols.

MozartNode enables symbolic transmission through structured acoustic signals. FIG. 5 depicts data (24) transmitted over wired (26), air (27), and water (28) channels, decoded through ASIBIM modules (23, 25).

All five components are interoperable and form an adaptive symbolic infrastructure. FIG. 9 and FIG. 10 show Teethlion proxies (39, 43) interacting with VPortOS interfaces (29, 44), network adapters (45), and routers (46), using libp2p transport adapters (41).

The system supports dynamic upgrades and extensibility. FIG. 13 shows the heartbeat mechanism, where nodes (59) send metadata (60) validated by authority systems (61). This ensures synchronization across the global multilayer deployment of FIG. 14.

### REFERENCE NUMERALS—ORDERED

1, the Teethlion P2P framework; 2, the CoreRotator module (portless session orchestration); 3, the GODLayer module (fragmented transport layer); 4, the ASIBIM module (symbolic overlays over binary); and 5, the MozartNode module (acoustic communication)./6, Application 1; 7, Application 2; 8, the SDK layer; 2, the CoreRotator module; 9, an ephemeral vhash generator; 10, the Portless Communication endpoint; and 11, the Client Application./12, fragmentation; 14, the Sender; 13, hyper-fragmentation (before and after the GODLayer); 3, the GODLayer; 15, defragmentation; and 16, the Receiver./17 shows how raw binary infrastructure signals, along with electromagnetic pulse timing/errors (18), are fed into a temporal pattern encoder (19) to produce symbolic QPKT data (20), which is then delivered to the receiver (21) and subjected to resilient interpretation (22) for robust, fault-tolerant decoding./23, implementation of ASIBIM (element 4 of FIG. 1); 24, sound signals including data; 25, decoding of ASIBIM (element 4 of FIG. 1); 26, a wired channel; 27, an air channel; and 28, a water channel. 29, the VPortOS module (time-based, deterministic); 30, the VPortAI module (AI-driven, heuristic); 31, the VPortQ module (quantum-based, probabilistic); and 32, the combined VirtualHashGen output./33, applications; 34, the VHash session flow; 2, core rotation; 35, virtual ports; and 36, physical ports./37, the Client; 38, the Server; 2, the CoreRotation module at each end; 9, the vhash generation/validation; and—Session established./39, the Teethlion proxy; 40, a decentralized communication application; 41, a libp2p-vhash-transport adapter; 29, the VPortOS secure network interface (element 29 of FIG. 6); and 42, the network./43, the Teethlion proxy; 44, the VPortOS secure network interface; 45, a network interface card compatible with vhash; and 46, a router compatible with vhash./47, Node A; 48, Node B; 49, Node C; 50, P2P connections between nodes; and 51, data streams (audio, video, messages, files)./52, the start; 53, dynamic role reassignment; 54, the user node role; 55, the bootstrap node role; 56, the relay node role; and 58, the end./59, the node; 60, the heartbeat flow with metadata; and 61, the authority system./62—Innermost LAN circle 63—Second ring (MAN) 64—Third ring (WAN) 65—Outermost ring (GAN) 54—User nodes (unfilled circles) 55—Bootstrap nodes (unfilled circles) 56—Relay nodes (unfilled circles) 66—AI nodes (filled circles) 67—Hybrid nodes (filled dark circles) 68—Standard encrypted P2P link (thin arrow) 69—AI-driven configuration link (curved arrow)

### BRIEF DESCRIPTION OF THE DRAWINGS

FIG. 1 is a block diagram of the modular architecture of the Teethlion system

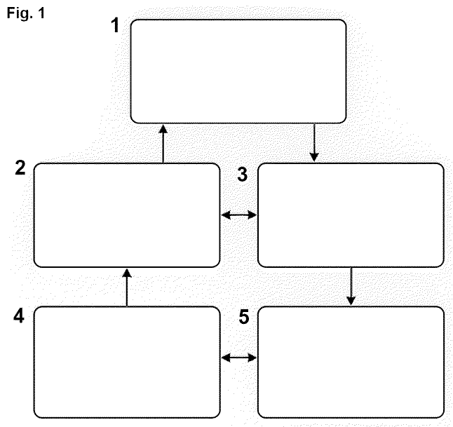

FIG. 2 is a flowchart of the CoreRotator session flow with VHash

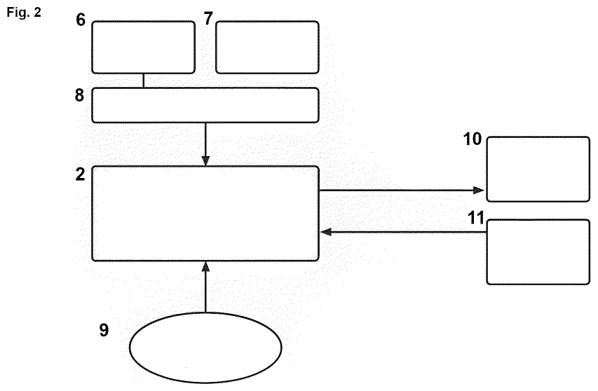

FIG. 3 is a flowchart illustrating the behavior of QPKT packets in the GODLayer

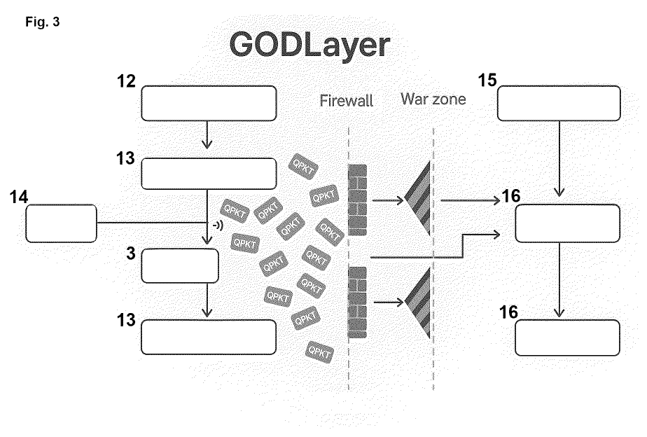

FIG. 4 shows how raw binary infrastructure signals are converted into symbolic QPKT data in ASIBIM.

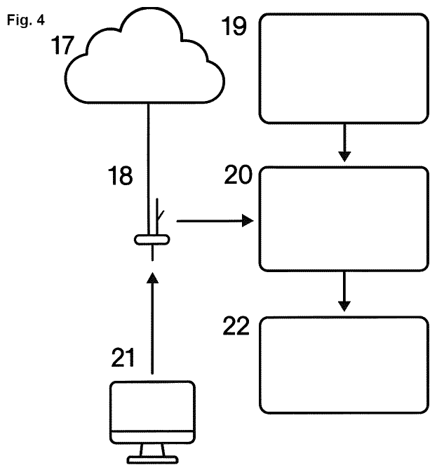

FIG. 5 is a flowchart of the MozartNode audio communication module.

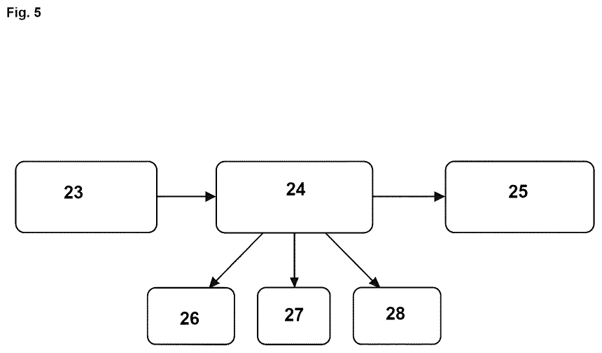

FIG. 6 is a block diagram comparing virtual hash generation in VPortOS, VPortAI, and VPortQ.

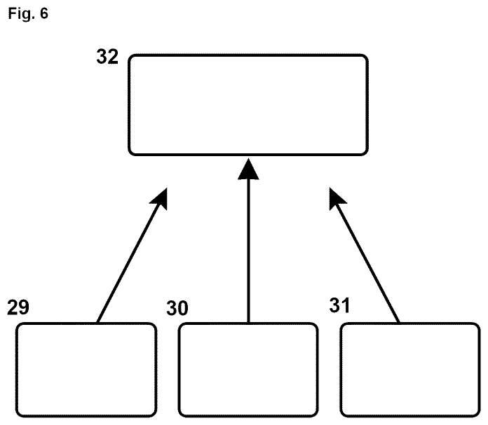

FIG. 7 is a block diagram of the logical architecture of VPortOS.

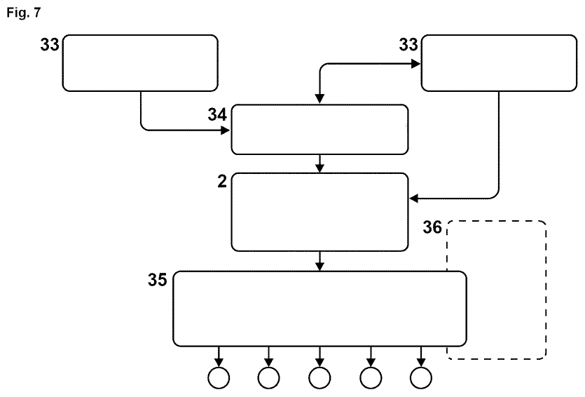

FIG. 8 is a flowchart of the vhash handshake protocol.

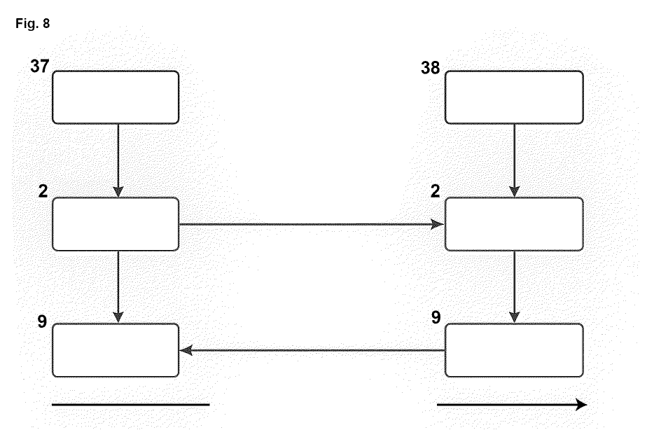

FIG. 9 is a flow diagram of Teethlion implementation over VPortOS.

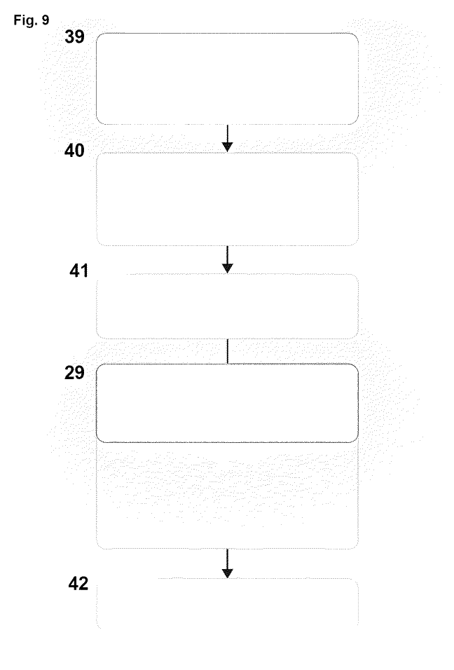

FIG. 10 is a flow diagram of Teethlion network stack over VPortOS.

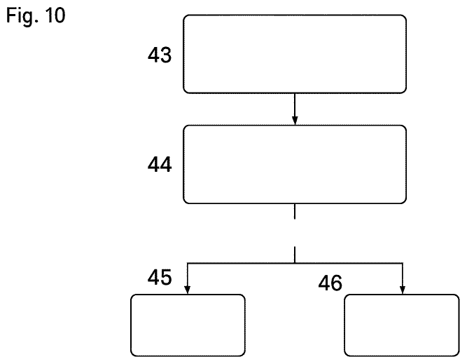

FIG. 11 is a schematic of an encrypted peer-to-peer overlay network.

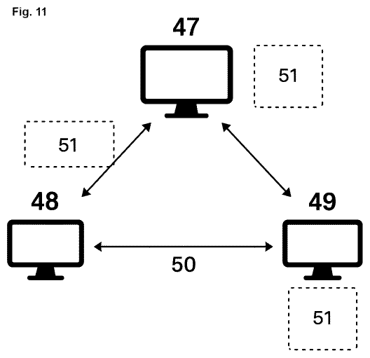

FIG. 12 is a flowchart of dynamic role reassignment among nodes.

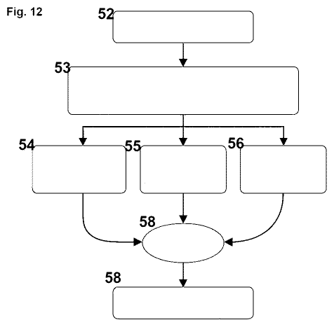

FIG. 13 is a block diagram of the encrypted heartbeat mechanism.

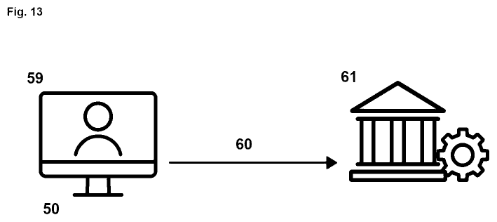

FIG. 14 is a schematic diagram of a multi-layer global network deployment.

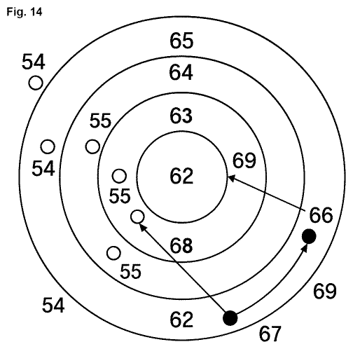

1. A decentralized and evolutive P2P communication system comprising symbolic binary and acoustic layers, portless addressing, and direct transmission without centralized servers or Internet.

2. The system of claim 1, wherein nodes dynamically assume extensible roles including user, relay, bootstrap, guard, honeypot, acoustic node, distributed AI node, IoT node, and future-defined symbolic nodes.

3. The system of claim 1, optionally incorporating a portless communication subsystem (CoreRotator) utilizing ephemeral hash-based identifiers (vhash) instead of network ports, as part of the system's evolutive architecture.

4. The system of claim 3, wherein CoreRotator manages session lifecycles via vhash rotation (using algorithmic, AI, or quantum methods), and applications interface through a subscription-based SDK; the system remains compatible with traditional port-based protocols during transition.

5. The system of claim 1, comprising an ultra-fragmented symbolic transport layer (GODLayer) for autonomous packet recomposition using QPKTs and multi-layer encoding, including quantum-inspired symbolic containers.

6. The system of claim 1, utilizing a symbolic pattern encoding layer (ASIBIM) which maps meaning to timing, rhythm, jitter, latency, pitch, amplitude, spacing, and emergent symbolic grammars.

7. The system of claim 1, including an acoustic transmission module (MozartNode) capable of structured symbolic emission and recognition via air and water using musical structures.

8. The system of claim 1, where compatibility is extended to current and future transport protocols including TCP, UDP, ICMP, QUIC, BLE, and evolving equivalents.

9. The system of claim 1, wherein role assignment, route selection, and symbolic flow orchestration are governed by CoreRotator through a subscription-based hash interface.

10. The system of claim 1, wherein symbolic transmission is adaptable to offline, underwater, encrypted, and hostile environments through modular encoding modes.

11. The system of claim 5, wherein a QPKT may include a null or empty payload and still convey symbolic meaning based on its transmission structure, entropy signature, or positional context within a sequence.
